(19) United States
(12) Patent Application Publication
(10) Pub. No.: US 2012/0050571 A1
(43) Pub. Date: Mar. 1, 2012

(54) IMAGE PICKUP DEVICE

(75) Inventor: Chen-Ping Yang, Taipei (TW)

(73) Assignee: DIGILIFE TECHNOLOGIES CO., LTD., Taipei (TW)

(21) Appl. No.: 13/101,610

(22) Filed: May 5, 2011

(30) Foreign Application Priority Data
Aug. 27, 2010 (TW) 099216597

(51) Int. Cl. H04N 5/76

(52) U.S. Cl. 348/231.99; 348/E05.031

(57) ABSTRACT

An image pickup device includes a main body, in which a processing unit is provided to electrically connect to a front image pickup unit mounted on a front side of the main body, an image display unit mounted to one side of the main body, a rear image pickup unit mounted on a rear side of the main body, and a memory unit and a power supply unit mounted in the main body. The processing unit has an image combination processing module for combining images picked up by the front and the rear image pickup unit into one image. With this design, images in front of and behind the image pickup device can be simultaneously captured and then combined into one to provide a photographer with more flexibility and fun in using the image pickup device.

### CROSS-REFERENCE TO RELATED APPLICATION

This non-provisional application claims priority under 35 U.S.C. §119 (a) on Patent Application No. 099216597 filed in Taiwan, R.O.C. on Aug. 27, 2010, the entire contents of which are hereby incorporated by reference.

### FIELD OF THE INVENTION

The present invention relates to an image pickup device, and more particularly to an image pickup device that is able to simultaneously capture images in front of and behind the device and then combine the captured images into one to thereby provide more flexibility and fun in photographing.

### BACKGROUND OF THE INVENTION

Various kinds of image pickup devices, such as digital camcorders or digital cameras, are frequently used by people in their daily life to capture scenery or figure images for different purposes, such as for viewing later or keeping as souvenirs.

A conventional image pickup device, either a digital camcorder or a digital camera, includes only one image pickup unit (i.e. one image pickup lens). To capture an image of some desired scenery or figure with such conventional image pickup device, simply direct the image pickup unit thereof toward the scenery or figure. And, the captured image would only show the target scenery or figure.

Therefore, the conventional image pickup device provides only a monotonous image capturing manner without other flexibility in use. For instance, when a photographer captures an image with the conventional image pickup device and wants to show himself in the captured image, the photographer must, for example, use a tripod or ask someone else to handle the image pickup device for him, and then locate himself in front of the image pickup device with the desired scenery as a background. However, in the event the photographer does not have a tripod or fails to find any one to help him, he can only capture the desired scenery image without including himself therein. That is, the conventional image pickup device does not allow a photographer to conveniently capture a desired image while showing him in the image to create more fun.

It is therefore tried by the inventor to develop an improved image pickup device that is able to simultaneously capture images in front of and behind the device and then combines the captured images into one image, so that the image pickup device provides more flexibility and fun in using it to capture images.

### SUMMARY OF THE INVENTION

A primary object of the present invention is to overcome the drawbacks in the prior art image pickup devices by providing an improved image pickup device capable of simultaneously capturing images in front of and behind the device and combining the captured imaged into one, so that a user may have more flexibility and fun in using the image pickup device to capture desired images.

To achieve the above and other objects, the image pickup device according to the present invention includes a main body, a front image pickup unit, an image display unit, a rear image pickup unit, a memory unit, a power supply unit, and a processing unit.

The front image pickup unit is mounted on the main body for picking up an image in front of the image pickup device; the image display unit is mounted to one side of the main body; the rear image pickup unit is mounted on the main body or the image display unit for picking up an image behind the image pickup device; the memory unit is mounted inside the main body for storing the captured images; the power supply unit is mounted on the main body; the processing unit is mounted inside the main body and electrically connected to the front and rear image pickup units, the image display unit, the memory unit and the power supply unit. The processing unit has an image combination processing module for combining the images picked up by the front and the rear image pickup unit into one image.

With the above arrangements, the front and the rear image pickup unit mounted on the main body can respectively pick up an image in front of and behind the image pickup device at the same time. For example, the forward faced front image pickup unit can pick up an image of scenery in front of the image pickup device and the rearward faced rear image pickup unit can pick up a photographer's image. The picked-up front and rear images can be then combined into one image by the image combination processing module of the processing unit. In this manner, the photographer can capture the desired scenery image without feeling sorry for not including himself therein.

In brief, with the above-described structure, it is possible to capture both images in front of and behind the image pickup device at the same time and to combine the captured front and rear images into one image, and therefore provide the photographer with more flexibility and fun in using the image pickup device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing a system configuration of an image pickup device according to a first embodiment of the present invention;

FIG. 2 is a front perspective view of the image pickup device according to the first embodiment of the present invention;

FIG. 3 is a rear perspective view of the image pickup device of the first embodiment in use;

FIG. 4 is another rear perspective view of the image pickup device of the first embodiment in use;

FIG. 5 is a rear perspective view of an image pickup device according to a second embodiment of the present invention; and

FIG. 6 is a rear perspective view of an image pickup device according to a third embodiment of the present invention.

### DETAILED DESCRIPTION OF THE PREFERRED EMBODIMENTS

The present invention will now be described with some preferred embodiments thereof and with reference to the accompanying drawings.

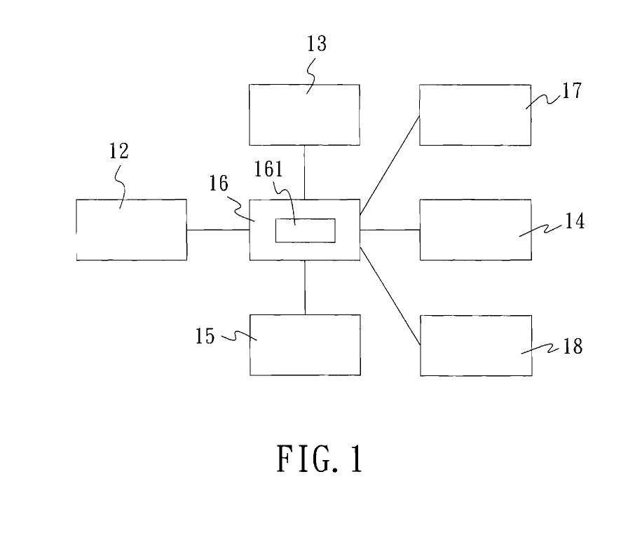

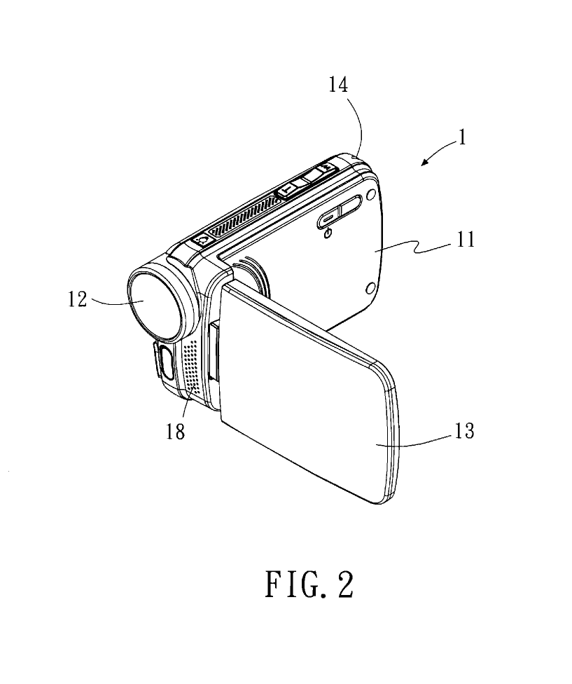

Please refer to FIGS. 1 and 2 at the same time. FIG. 1 is a block diagram showing the system configuration of an image pickup device according to a first embodiment of the present invention, and FIG. 2 is a front perspective view of the image pickup device in the first embodiment of the present invention.

As shown, the image pickup device in the first embodiment, which is generally denoted a reference numeral 1, is configured as a digital camcorder and includes a main body 11, a front image pickup unit 12, an image display unit 13, a rear image pickup unit 14, a memory unit 15, a processing unit 16, and a power supply unit 17.

The front image pickup unit 12 is mounted on the main body 11 for picking up an image in front of the image pickup device 1. The image display unit 13 is mounted on the main body 11, such as being movably connected to the main body 11. The rear image pickup unit 14 is mounted on the main body 11 for picking up an image behind the image pickup device 1. The memory unit 15 is mounted inside the main body 11 for storing images picked up by the front and rear image pickup units 12 and 14. The power supply unit 17 is also mounted on the main body 11. The processing unit 16 is mounted inside the main body 11 and electrically connected to the front image pickup unit 12, the image display unit 13, the rear image pickup unit 14, the memory unit 15 and the power supply unit 17. The processing unit 16 includes an image combination processing module 161 for incorporating the image picked up by the rear image pickup unit 14 into the image picked up by the front image pickup unit 12.

The front image pickup unit 12 can be mounted to a front side of the main body 11 for picking up an image in front of the image pickup device 1, while the rear image pickup unit 14 can be mounted to a rear side of the main body 11 for picking up an image behind the image pickup device 1.

The front and the rear image pickup unit 12, 14 can respectively include a general image pickup lens and an image sensing element, such as CMOS (Complementary Metal-Oxide-Semiconductor) or CCD (Charge-Coupled Device). The image display unit 13 can be a general image display screen movably connected to one lateral side of the main body 11, so as to be pivotally turned relative to the main body 11 between an opened and a closed position. Alternatively, the image display unit 13 can be directly mounted to the rear side of the main body 11. The power supply unit 17 can be a battery (not shown) or a general power cord (not shown) for connecting the image pickup device 1 to an externally power source.

Further, in the illustrated first embodiment, the image pickup device 1 also includes an audio input/output (I/O) unit 18, which is also mounted on the main body 11 and electrically connected to the processing unit 16.

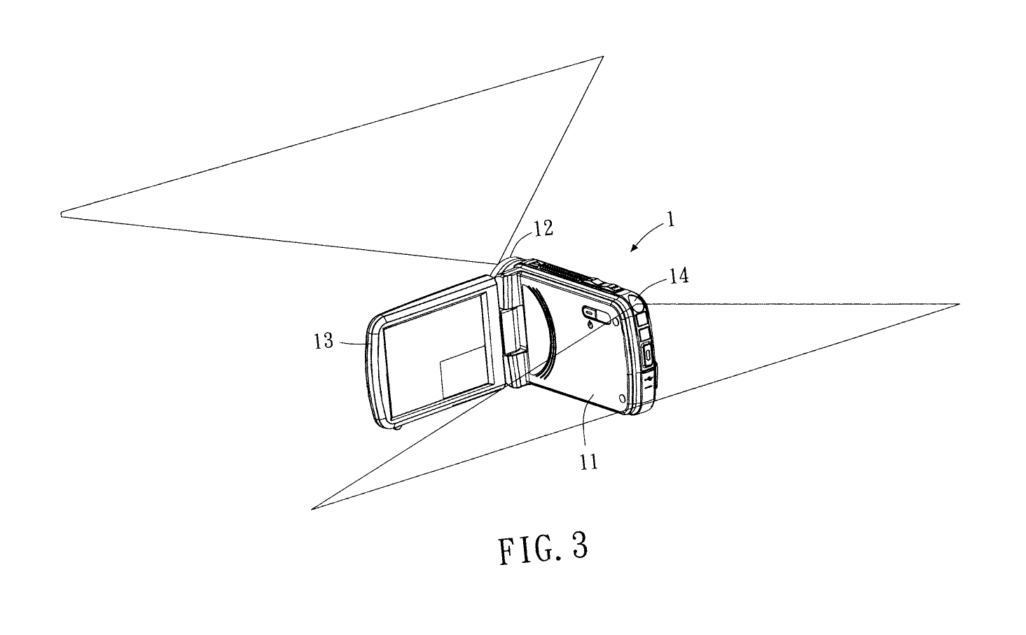

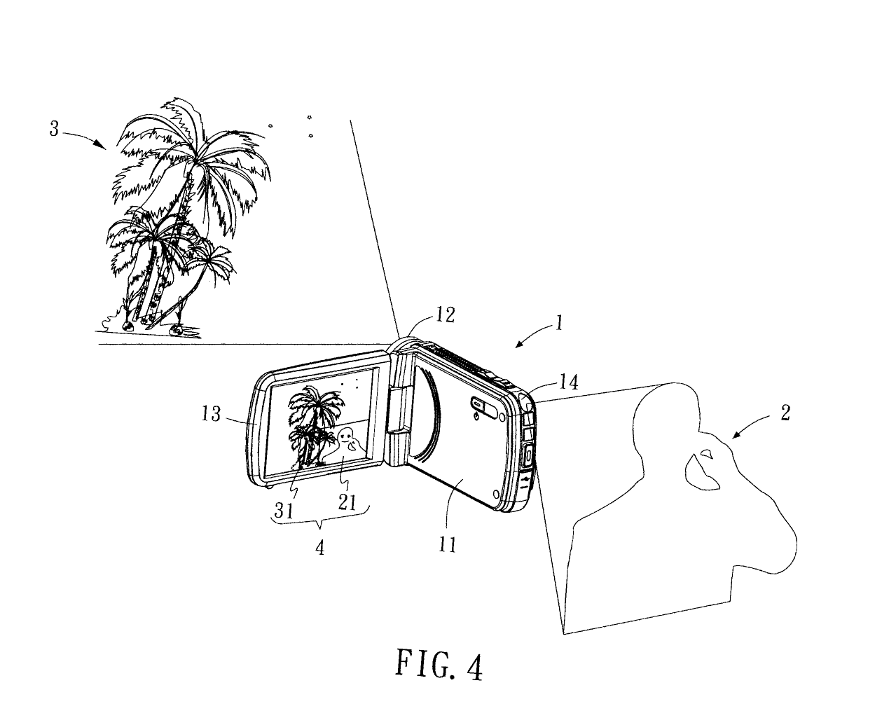

Please refer to FIGS. 3 and 4 that illustrate the image pickup device 1 of the present invention in use.

To use the image pickup device 1, which is a camcorder in the first embodiment, a photographer 2 holds the main body 11 with one hand and directs the front image pickup unit 12, which is mounted to the front side of the main body 11, toward desired scenery 3. Meanwhile, the rear image pickup unit 14 located at the rear side of the main body 11 would be directed toward the photographer 2. With this position, the front image pickup unit 12 is able to pick up an image 31 of the scenery 3 while the rear image pickup unit 14 picks up an image 21 of the photographer 2. The processing unit 16 would then incorporate the photographer's image 21 into the scenery image 31 to produce a combined image 4, such as a two-in-one image. The combined image 4 is stored in the memory unit 15 and can be displayed on the image display unit 13.

By providing the front image pickup unit 12 and the rear image pickup unit 14 on the main body 11, it is able to capture both images in front of and behind the image pickup device 1 at the same time, such as the scenery image 31 and the photographer's image 21 shown in FIG. 4. Then, the image combination processing module 161 of the processing unit 16 combines the scenery image 31 and the photographer's image 21 into one combined image 4. With these arrangements, the photographer 2 can capture the desired scenery image 31 without feeling sorry for not including himself therein 31.

In other words, with the present invention, it is possible to capture both images in front of and behind the image pickup device 1 at the same time and to combine the front and the rear images into one image, and therefore provide a photographer with more flexibility and fun in using the image pickup device to capture desired images.

In using the image pickup device 1 of the present invention to capture images, it is also possible to record the photographer's voice and/or surrounding sounds via the audio I/O unit 18 mounted on the main body 11, and the recorded sounds can be played back along with the captured images.

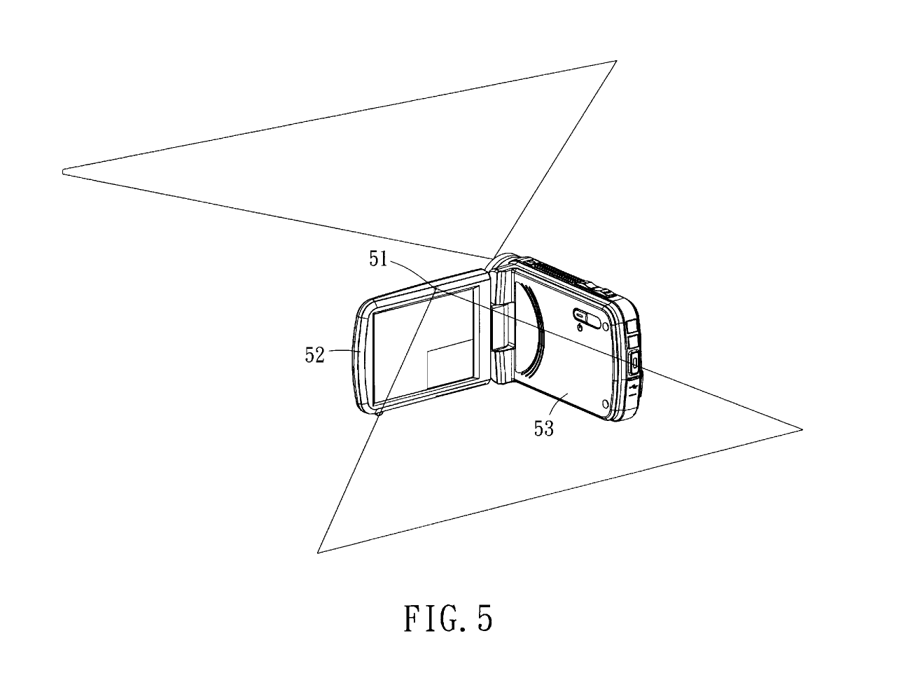

Please refer to FIG. 5 that is a perspective view of an image pickup device according to a second embodiment of the present invention. The image pickup device in the second embodiment is generally structurally similar to the first embodiment, except for a rear image pickup unit 51 that is mounted on one side of an image display unit 52 to face toward a rear side of a main body 53 of the image pickup device. With the rear image pickup unit 51 mounted on the image display unit 52, the image pickup device in the second embodiment can also provide the same functions and benefits as the first embodiment.

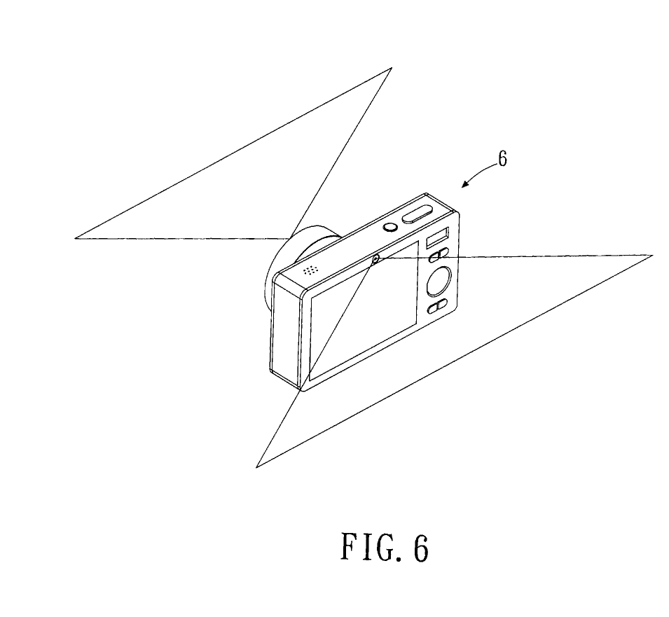

FIG. 6 is a perspective view of an image pickup device 6 according to a third embodiment of the present invention. The image pickup device 6 in the third embodiment is generally structurally similar to the image pickup device 1 in the first embodiment, except that it is in the form of a digital camera. However, the image pickup device 6 in the form of a digital camera can still achieve the same functions and benefits as the first embodiment.

The present invention is novel and improved because the front and rear image pickup units enable a photographer to simultaneously capture images in front of and behind the image pickup device, and the image combination processing module enables the captured front and rear images to be combined into one image and show the photographer therein, which no doubt provides increased flexibility and fun in using the image pickup device of the present invention. The present invention is also industrially valuable because products derived from the present invention would no doubt fully satisfy the current market demands.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An image pickup device, comprising:
a main body;
a front image pickup unit being mounted on the main body for picking up an image in front of the image pickup device;
an image display unit being mounted to the main body;
a rear image pickup unit being selectively mounted on the main body or the image display unit for picking up an image behind the image pickup device;
a memory unit being mounted inside the main body for storing the picked-up images;
a power supply unit being mounted to the main body; and
a processing unit being mounted inside the main body and electrically connected to the front image pickup unit, the image display unit, the rear image pickup unit, the memory unit and the power supply unit; and the processing unit including an image combination processing module for combining the images picked up by the front and the rear image pickup unit into one image.

2. The image pickup device as claimed in claim 1, wherein the front image pickup unit is mounted on a front side of the main body, and the rear image pickup unit is mounted on a rear side of the main body.

3. The image pickup device as claimed in claim 1, further comprising an audio I/O unit, which is mounted on the main body and electrically connected to the processing unit.

4. The image pickup device as claimed in claim 1, wherein the image pickup device has a configuration selected from the group consisting of a digital camcorder and a digital camera.
